(19) United States
(12) Patent Application Publication
(10) Pub. No.: US 2011/0209041 A1
(43) Pub. Date: Aug. 25, 2011

(54) Discrete voice command navigator

(76) Inventor: Saad Ul Haq, London (GB)

(21) Appl. No.: 12/801,814

(22) Filed: Jun. 28, 2010

(30) Foreign Application Priority Data
Feb. 19, 2010 (GB) GB1002848.8

(51) Int. Cl. G06F 17/21

(52) U.S. Cl. 715/208

(57) ABSTRACT

Disclosed is a discrete voice-activated navigation software enabling users to navigate through web-pages displayed in an internet browser by simply uttering a discrete character assigned to a hyperlink by an algorithm. This algorithm scans a webpage locating text hyperlinks and identifying any unique letter(s) within the hyperlink, i.e. all characters are matched against a database of already used tags in order to find a unique character. If available, it is assigned. If no single character is available, then a continuous set of double and if needed triple lettered tags are assigned. Illustrative hyperlinks can be activated by the selection of tags on sideline grids providing a non-intrusive alternative to clicking. Logically, differences in emphasis, pronunciation, tone, amplitude and pitch are far too great to invoke the correct response if a whole word is said. Thus discrete characters would provide least audible differences resulting in minimal errors or processing difficulty.

This invention relates to the use of discrete voice activated tags allowing easy navigation through the web-pages displayed by a web browser.

Today's limitation to the processing of the continuous speech of a user has led to the limited use of voice-recognition software systems. Furthermore, the extensive training and retraining for every new user has further abolished any logical reason to use such systems. When used by the same person, such systems still behave and react differently every time the same command is said due to voice differences related to stress, time of day, emotion and sickness. Logically, speaker independent voice commands must become shorter and more discrete leaving little or no detectable audible difference every time the word is said.

The inherently difficult problem of user-friendly speech recognition system lies in the fact that computing devices are deterministic machines and their design and architecture allows for no tolerance when comparing two values that do not match 100% such as our speech commands to stores in the computer's memory.

Conventional voice-recognition systems rely on the utterance of whole words or sentences, usually long and thus difficult to process. Software such as word processing have been developed which respond to user speech but the accuracy depends on the initial training of the application to the user's voice profile.

However, these applications have very little tolerance of any deviation of the voice profile of the user. This has stemmed input speed and slowed processing time.

Alternatively, this invention deals with the use of voice-activated tags that are assigned to hyperlinks on a webpage. These provide an easy method of navigating through websites based on the fact that nowadays the miniaturisation of processors from wearable computers and E-books to mobile devices have made peripherals such as the keyboard and mouse too large a bulk to carry or integrate.

The main focus of this invention is in the use of wearable computers in scenarios where hands-on professionals need an alternative mechanism of input over conventional wrist keyboards and track pads which not only require a free hand that would otherwise be busy on a work site but also their own power supply, means of attachment to the system and most of all portability and miniaturisation at a reasonable scale. Thus the conditions are rife for a system that can deal with any person at any time without the dependence of continuous and time-consuming training procedures.

### Text Hyperlinks:

This invention is based on a Divide and Conquer algorithm that will intercept a webpage, scan, locate and assign discrete yet unique non-intrusive characters to hyperlinks.

This can include text, diagrams, pictures, videos and animation. Text (numbers and letters) is formatted based on a character that is found in the hyperlink and not in any other hyperlink (the loops also apply to numbers in a similar manner although only letters are discussed below). Processing methods for text-only hyperlinks is a series of three loops based on the frequency of these text hyperlinks: It scans the webpage, identifying all hyperlinks (both text and graphic hyperlinks are identified, however for now, the process for text-only hyperlinks will be dealt with for simplicity). The plug-in algorithm then checks for the presence of either a single-unique-letter, double-unique-letters or triple-unique-letters (in this order) in each hyperlink. All single-unique-letters will be acted on in this first loop. All other hyperlinks containing double and triple-unique-letters will be indexed. In the second loop, all double-unique-letters will be acted upon. In the third loop the remaining indexed triple-unique-letter containing hyperlinks will be acted upon. In this way, all text hyperlinks would have been acted upon thus tagged by the end of the third loop.

So basically, once all single-unique-letter containing hyperlinks have been formatted, the processor then returns to the first indexed hyperlink to begin the second loop. It acts on only those with a set of two unique repeating letters, once again leaving those words with no unique double letters unformatted and double indexed. The processor then returns to the first double indexed hyperlink, it then only acts on those with triple-unique-letters. This will only happen three times as the maximum formatting loops set by the algorithm is three. Preference is given to first occurring hyperlinks and the single-unique-letter, meaning that as you descend the document, the number of hyperlinks containing single-unique-letters would typically reduce in frequency. Typically, that means that the size of the tag would gradually increase. The defined limit of three is to ensure maximum efficiency with least processing difficulty. It must be kept in mind that the same method applies to hyperlinks containing numbers or numbers and letters together.

So basically, the divide and conquer algorithm is a means of dividing up a task into smaller tasks. In case of text, firstly, the algorithm separates all hyperlinks, thus reducing amount to be processed. Then the algorithm identifies all SUL, DUL and TUL. The 2nd loop only processes DUL. The 3rd loop only processes TUL (processing here means formatting). So by dividing up the problem into smaller parts and solving each part, this algorithm creates categories of different hyperlinks; i.e. those containing a SUL, a DUL and a TUL (3 categories). The hyperlinks containing formatted letters map onto voice commands (respond to user speech). If user speech matches the letters, then the hyperlink is activated. If not matched, then it is ignored.

Basically, in case of text, the method of formatting SUL, DUL and TUL has been summarised and compressed into 3 steps. The body of text is scanned for all text hyperlinks, it isolates these hyperlinks hence dividing up the web page, however this process is not visible to the user as it occurs before the webpage is loaded onto the screen. The first hyperlink is scanned, any single letter is selected. As priority goes to SUL, therefore DUL and TUL will only be selected/identified and then formatted once all such single unique letters are exhausted (a maximum of 26, as there are only 26 letters in the alphabet, however some links may contain numbers in the hyperlink word too, so therefore this value will be slightly larger to take into account number and letter combinations).

The second hyperlink is scanned; a single letter is selected from the word (in order of left to write), if that letter is already taken by a previous hyperlink, then another single letter is found, if that too has already been used then the next letter is selected and so on. When all single letters in the word have been scanned and there is still no unique single letter, then a double letter will be selected and compared through the same process mentioned above. And once all double letters have been used up and no more unique double combinations are available in a word, then triple letter are selected and scanned through a similar process. Note that this is still the first loop as identification of all SUL, DUL and TUL is still going on. Then all SUL are formatted (color, font and size change), the first loop will end once the above is carried out. It must also be noted that when DUL and TUL are selected, the letters are side-by-side and not apart, as explained in the following example:

Consider the word ‘Sands’. It is a hyperlink from a webpage,
All possible single-unique-letter (SUL) combinations are: s, a, n, d (the last ‘s’ is ignored as there is already an ‘s’ earlier on in the word).
All possible double-unique-letter (DUL) combinations are: sa, an, nd, ds.
All possible triple-unique-letter (TUL) combinations are: san, and, nds.

In general, it would be observed that a standard web-page once acted upon by the algorithm, would obviously have a different number of SUL, DUL and TUL. Logically and typically, the number of SUL would decrease on descending/scrolling down the page, because the number of single unique letters is limited. If a page were to be divided up into 3 parts, the first part would have a majority of SUL, the second part would have a majority of DUL and the third part would have a majority of TUL. Please note that this is true only when assuming that the page is sufficiently large enough or contains enough hyperlinks to enter the third loop of the algorithm (once all SUL and DUL combinations have exhausted), i.e. resort to the selection of TUL in hyperlinks.

The loops are a way of scanning the web-page from top to bottom and identifying hyperlinks and formatting them. If in the 1st loop, it doesn't succeed to format all the hyperlinks, 2nd loop will begin and so on and so forth, as described below with an accompanying example:
1st loop: —Identifying all hyperlinks,
   Identifying existence of either 1, 2 or 3 unique letters in the hyperlinks,
   Formatting of those hyperlinks with 1 unique letter.
2nd loop: —Formatting of those hyperlinks with 2 unique letters only.
3rd loop: —Formatting of those hyperlinks with 3 unique letters only.

Example: A body of text found on a web-page containing various hyperlinks (underlined, italic and blue):

“Avogadro's constant is the number of elementary entities in one mole of a substance. It has the same quantity as the relative atomic mass of a substance in grams. A mole is the amount of substance that contains 602300000000000000000000 particles in it. This is a fact. This page has been relocated from the definition of mole.”

### Loop 1: —Identifying and Listing all Hyperlinks:

Avogadro's constant, elementary, entities, mole, substance, quantity, relative atomic mass, grams, particles, fact, page, relocated, definition, mole.

### Identifying SUL, DUL or TUL in Each Hyperlink:

| | |
|---|---|
| Avogadro's constant | (A)-SUL |
| elementary | (E)-SUL |
| entities | (N)-SUL |
| mole | (M)-SUL |
| substance | (S)-SUL |
| quantity | (Q)-SUL |
| relative atomic mass | (R)-SUL |
| grams | (G)-SUL |
| particles | (P)-SUL |
| fact | (F)-SUL |
| page | (PA)-DUL |
| relocated | (L)-SUL |
| definition | (D)-SUL |
| mole | (M)-SUL |

Note that there are two hyperlinks with the same wording; mole, since they would both lead to the same page they have been given the same tag; M.

### Formatting Action on SUL:

Avogadro's constant, Elementary, eNtities, Mole, Substance, Quantity, Relative atomic mass, Grams, Particles, Fact, reLocated, Definition, Mole.

### Loop 2: —Formatting Action on DUL:

PAge

### Loop 3: —Formatting Action on TUL: No TUL so Loop 3 is not Carried Out.

Preprocessing complete, page is now voice-enabled and ready to be displayed to the user on the browsing window as shown.

“Avogadro's constant is the number of Elementary eNtities in one Mole of a Substance. It has the same Quantity as the Relative atomic mass of a substance in Grams. A mole is the amount of substance that contains 602300000000000000000000 particles in it. This is a fact. This PAge has been relocated from the Definition of Mole.”

All the hyperlinks on the page have been indexed and formatted based on the 3 loop algorithm. The page is now available to the user to freely navigate using voice commands. We feel that 3 loops are sufficient to uniquely identify and format all the hyperlinks on a page. However, in principle, it could continue beyond the selection and formatting of three-unique-letters (the product of the third and last loop) but it is highly unlikely. As mentioned earlier, the function of each loop is to uniquely identify and format unique letters (either 1, 2 or 3 based on which loop of the three loops) in each of the hyperlinks, which the user can say/speak in order to activate the link.

So basically what act the loops perform on hyperlinks that are indexed is that they formats already identified-unique-letter(s), making them prominent and allowing the user to identify the hyperlink as a voice enabled hyperlink (voice tag). Before all this, the algorithm identifies SUL, DUL or TUL in each hyperlink.

Theoretically, it may be possible to uniquely identify every hyperlink on a page by a SUL, thus requiring only the first loop. However, in some cases, a page may contain two hyperlinks with the same single letter, in this case the user's voice command would not be able to distinguish between both hyperlinks. If every other individual letter in that word is similarly unavailable, a second loop is necessary in which the algorithm will now format double letters. If required, the algorithm can proceed further until all hyperlinks on the display page can be uniquely identified by either a SUL, DUL or TUL.

### Illustrative Hyperlinks:

The illustrative hyperlinks or those that contain no relating adjacent text can be selected by a horizontal grid at one side (top or bottom) and a vertical at the other (left or right). These grids will have distinct character combination that will be assigned as long as there is an image hyperlink in its path. Note that if there is no picture hyperlink in a line, then no combination tags would appear on that horizontal and vertical line. Paraphrasing the above, side-line grids are voice-activated combinations that allow the user to specifically define a picture or a graphic within the body of the web-page. Like a cell in a spreadsheet can be defined by stating the row and column one after the other in any order; but both the row and column must be stated in the excel sheet to select a single cell. The side-line grids are introduced/super-imposed onto the newly loaded page on the top and on the left. Their function is to primarily activate videos, images, animations and graphics by voice-commands. They allow the selection of illustrative hyperlinks that do not have related text beside them. In normal circumstances, the user would otherwise click on them to activate them.

A standard html page, when loaded onto a browser, like a Wikipedia page, contains hyperlinks which have been formatted in such a manner: underline, italic, blue (typically). In this patent, new formatting is super-imposed on top of the typical standard formatting by the algorithm for each tag in a hyperlink, before it is loaded. The formatting mentioned in this patent refers to:
1. Color, size, font change of the SUL, DUL or TUL, (however, to the remaining letters in the hyperlink, there would be standard hyperlink formatting—underline, italic and blue),
2. These newly formatted letters can now be activated by voice commands by the user (please note that this new formatting is done by the algorithm discussed in this patent and occurs just before the page is loaded onto the browser window)

The plug-in, which integrates all the features of the disclosed patent, is an algorithm that is downloaded onto the client's machine. This algorithm sits between the browser and the Internet. Any web-page that is loaded onto the browser must first pass through this algorithm in order for the page to be preprocessed before being loaded onto the browser. The algorithm also interfaces a speech recognition software stored on the client's machine with the web-browser. The overall function of the algorithm is to convert the requested page into a voice-enabled page. This software also matches the spoken words by the user with the speech recognition software in order to activate links on the web-page. When the user says the letter (or any other form: number, combination of number and letter) through the microphone, the algorithm maps the letter to the letter in the body of the text. Since there are only unique combinations of letters, that specific word gets activated. The word is hyperlinked to another web-page and thus the hyperlink gets activated and the web browser directs the page to that corresponding webpage.

### Voice-Activated Tag:

How it works: In each of the hyperlinks, a unique combination of letters (either SUL, DUL, or TUL) becomes associated with a voice tag. So when the user speaks or pronounces into the microphone the specific unique letters or their combinations, the speech recognition software correlates the letter to the spoken sound. This correlation allows the user to activate the hyperlink on the page.

When it works: They work when the user speaks the uniquely identified voice tags, and a one-to-one correlation/mapping is achieved.

How they are created: They are created automatically through the looping algorithm discussed earlier at the instant before the page is loaded onto the user's browser. The newly loaded page is displayed and tagged for voice activation.

When they are created: They are created by the looping algorithm at the instant before the page is loaded onto the browsing window.

Paraphrasing all of the above and previous, the overall action of the plug-in goes through following stages:
1. First, algorithm identifies all hyperlinks,
2. Then finds SUL, DUL, TUL in hyperlinks,
3. Reformats the uniquely identified letter(s) into an easy recognizable format—such as size and color changes,
4. When the fully voice enabled page is loaded into the users browser, the user can identify the hyperlinks by the formatted unique letters and then activate them by saying that letter(s) into the microphone.

The speech recognition software allows one-to-one mapping between the user's spoken letters to the associated letters of the hyperlink. If the speech recognition is able to match the spoken word with the unique hyperlinks, the hyperlink becomes activated and the user is able to successfully navigate using voice commands. What part of the tagging system that actually succeeds in navigation through web-pages is the identification and formatting of SUL, DUL and TUL and then creating a link between the unique combinations and the voice/data entered through the microphone by the user.

The invention can be directly implemented within any type of web browsing software and almost any electronically driven interface where a mouse, keyboard or stylus would be needed. Such as Television remote controls, mobile devices, gaming consoles, digital cameras and wearable computers and DVD players used by people such as inventory control personnel, cashiers, officers in the navy, army and air force and police force.

It can also intercept any application and software program and thus provide a voice-activated interface for the program every time it starts up. If not needed, it can be turned off at will from a user parameter setting window. This executable plug-in will be developed in such a way that the user will be able to install it and set the parameters to the way in which the letters will be tagged and the images displayed. This is done to control what the user would see after parsing the page; font color, font size, font style and user defined permanent tags.

As mentioned above, the user has the option of setting their own permanent tags to such hyperlinks that occur very often in most web pages. Hyperlinks such as: Sign in, Images, Videos and News are just some examples of this feature that allow the user to define these permanent tags. The advantage being the memorization of these tags by the user, providing even faster navigation.

Based on the disclosed algorithm, over 15,000 different hyperlinks can be dealt with and displayed successfully. However, hyperlinks that reoccur and load to the same page must be recognized by the software. It must then assign exactly the same tags to those repeating hyperlinks. The algorithm can deal with almost anything visible on a screen; menus, scroll bars, sliding bars, etc. Since menus are all text, the basic principle for tagging text is similar to that mentioned above.

When any of the drop-down menus in a browser is opened, it will come into focus shadowing everything around it. This shows that other tags that might have been visible on the page are now inactive and hence reused in the menu until that menu is closed.

Scroll bars can be moved up/down or left/right by uttering a unique yet short combination of characters to either move the scroll bar a fixed user defined amount or a continuous movement until the same combination is re-said. Similarly, whenever a new window such as a ‘Save as’ screen is opened, the tags are reused and applied to any clickable text. If an icon is present with no text, then the plug-in will superimpose any text near the icon that would otherwise be visible when the mouse is hovered over it.

A typical scenario would go through the following sequence of events in the voice-activated browser described in this patent:

1. The user opens up a regular web browsing software,
2. Enters a URL into the address bar (by any means),
3. Before the page is actually loaded and made visible to the user, it is preprocessed by the algorithm defined in this patent—in the preprocessing, in the 1st loop of the algorithm, all text hyperlinks are identified, and a SUL, DUL or a TUL is identified within each hyperlink.

All SUL are then formatted.

In the 2nd loop, all DUL are formatted.

In the 3rd loop, all TUL are formatted.

Now all text hyperlinks are voice-activatable.

The algorithm also introduces bars at the top and left (with numbers and letters in it), which are associated with all other hyperlinks, except text, i.e. graphics. Preprocessing is now completed and the web-page is now loaded onto the browser window.

4. The user can now activate any of the hyperlinks:
i. Can activate any of the hyperlink text by saying the SUL, DUL or TUL into the microphone, the letter spoken by the user is digitized by standard voice-recognition software, like Dragon Talk TM which maps it to the hyperlinks that contains those spoken letters. The plug-in will enable the voice recognition software to work with the web-browser (middleware). The plug-in is an interface between the algorithm and the standard voice-recognition software
ii. Similarly, graphics can also be activated in a similar manner by speaking the corresponding combination; i.e. the image in a specific row and column of the side-line bars. For e.g. the cell ‘A5’ in a spreadsheet, will be in the 1st row and 5th column. Please note that the bars will only appear wherever there is a graphic hyperlink in the same row or column.

The invention will now be described solely by way of example and with reference to the accompanying drawings in which:

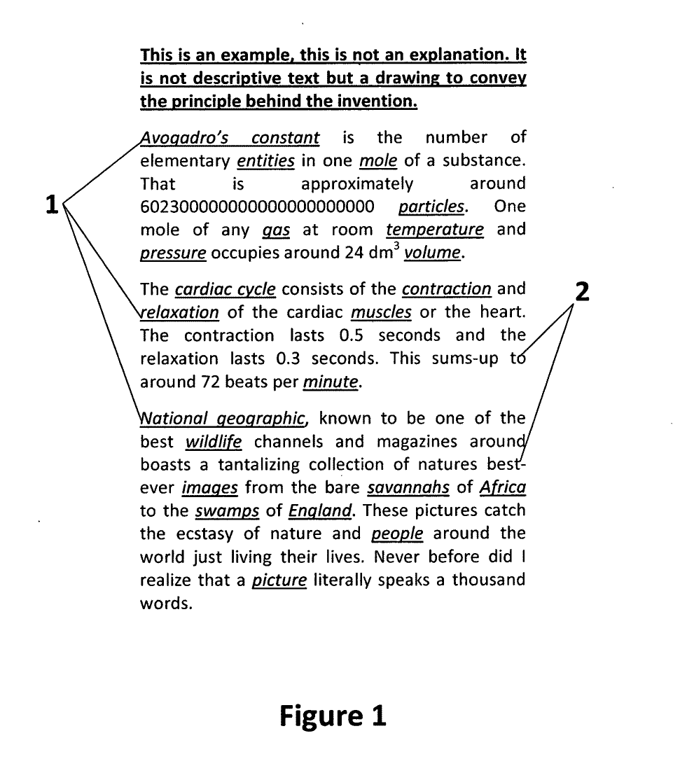

FIG. 1 shows an example of a regular text-only webpage that a normal web browser would display as shown, where the hyperlinks are italic and underlined and colored differently from the normal text,

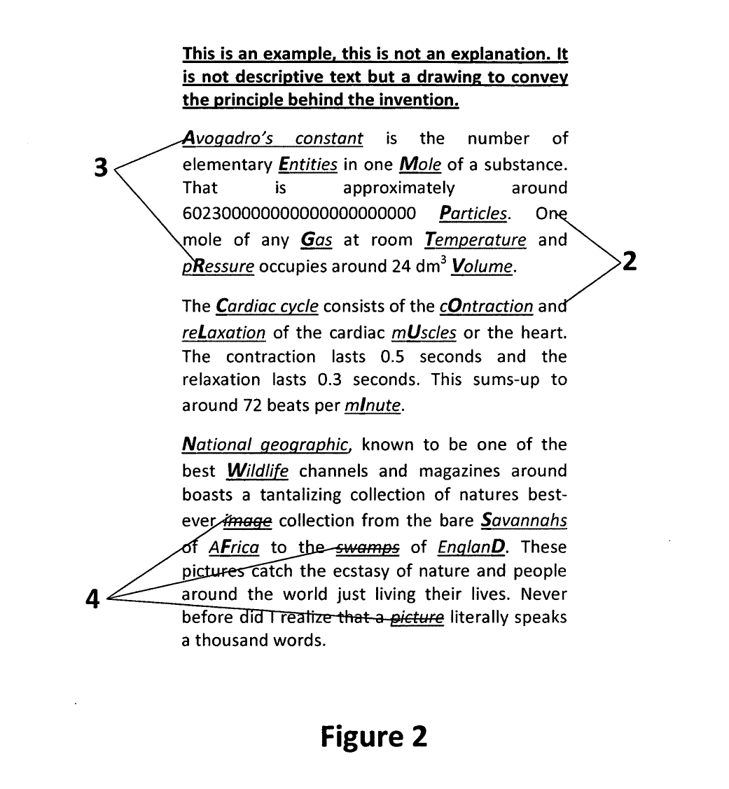

FIG. 2 shows the first loop of the algorithm which only acts on and tags hyperlinks that contain single unique letters, otherwise the hyperlink is indexed (striked, highlighted) but not acted on or tagged,

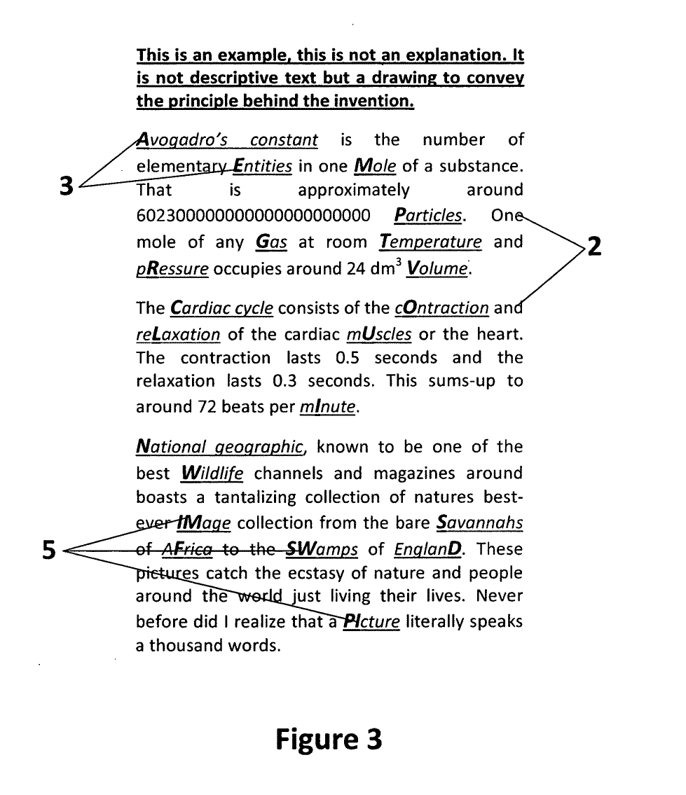

FIG. 3 shows the final screen (in this case) that has all hyperlinks acted on including those with double unique letters, this screen will be viewed to the user,

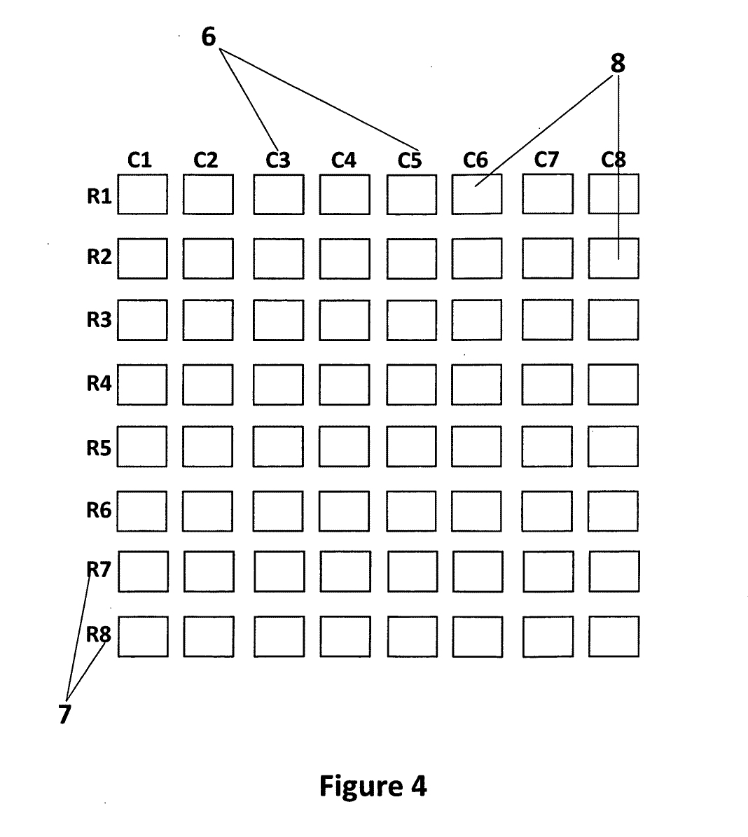

FIG. 4 shows a picture-only webpage in which each small box is a different hyperlink that once activated opens a different page from the other, the webpage also has the grid applied to it for voice selection,

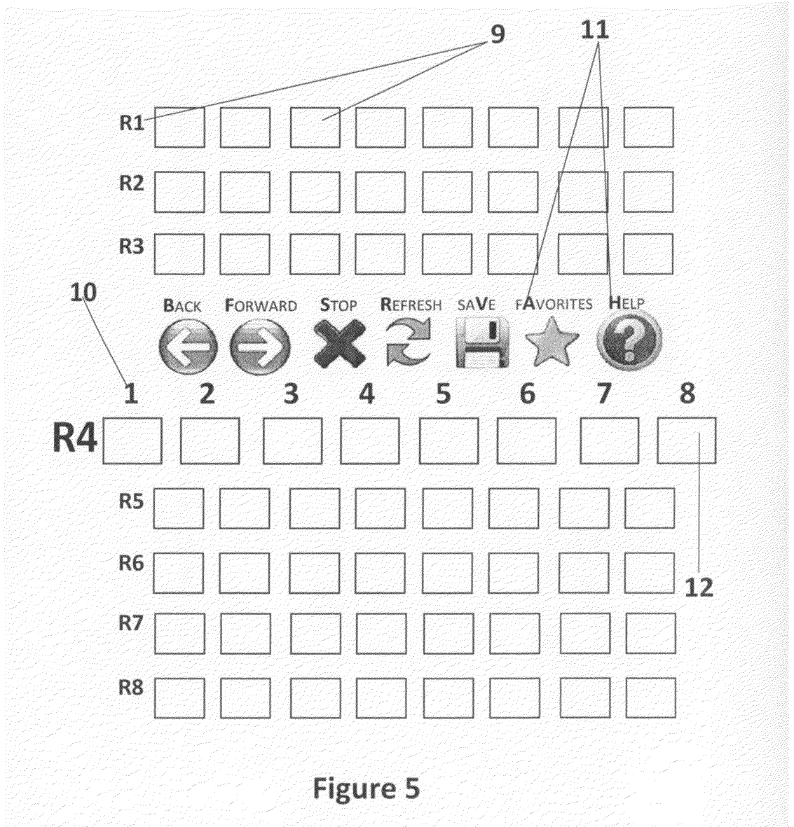

FIG. 5 shows what happens once a row (R4) is selected from the grid shown in FIG. 4 and also all the options that appear once a selection is made,

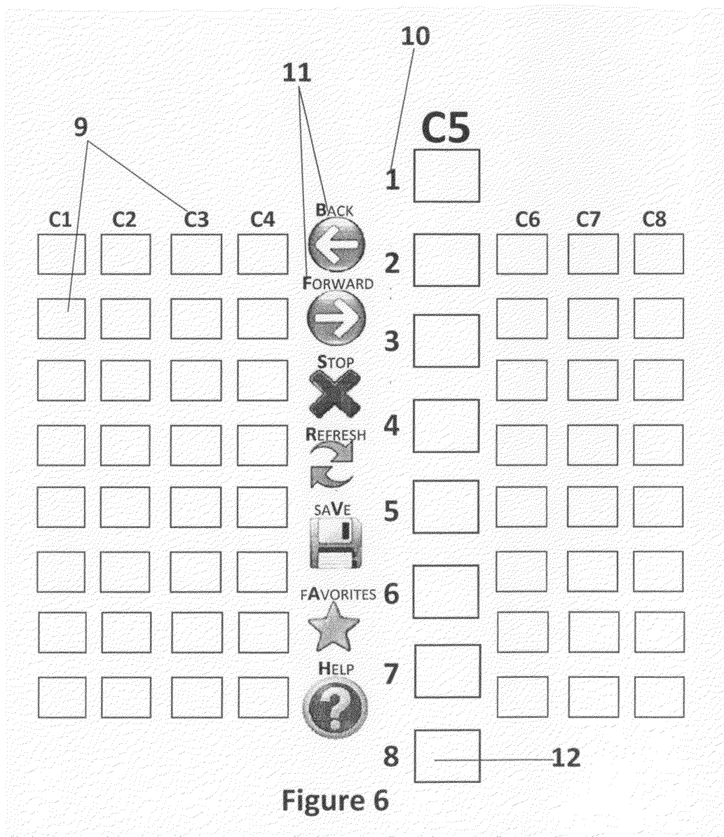

FIG. 6 shows what happens once a column (C5) is selected from the grid shown in FIG. 4 and also all the options that appear once a selection is made,

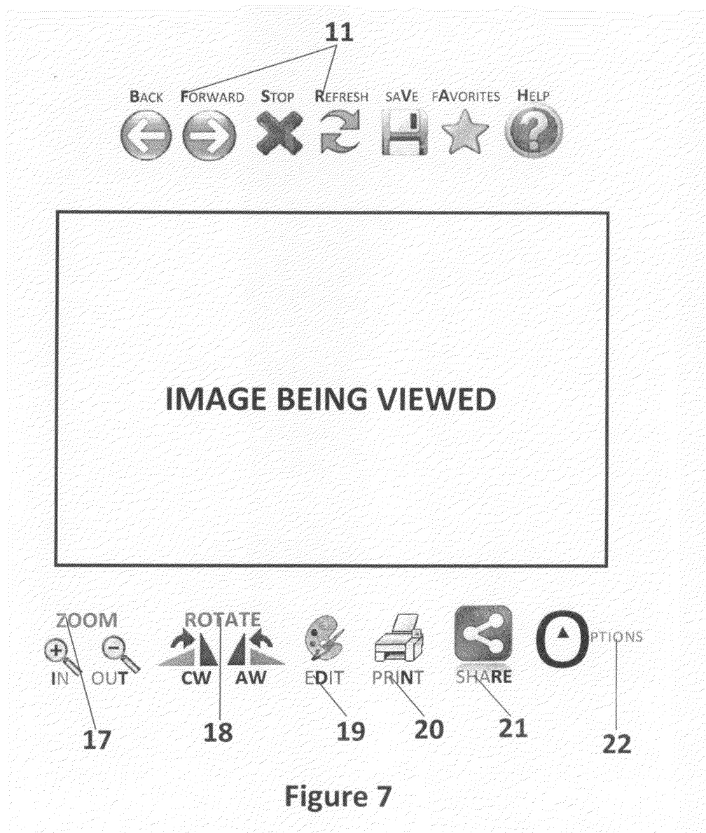

FIG. 7 shows a full window that will be visible once a certain image is selected; an enlargened version of the desired image along with navigation options and further viewing options,

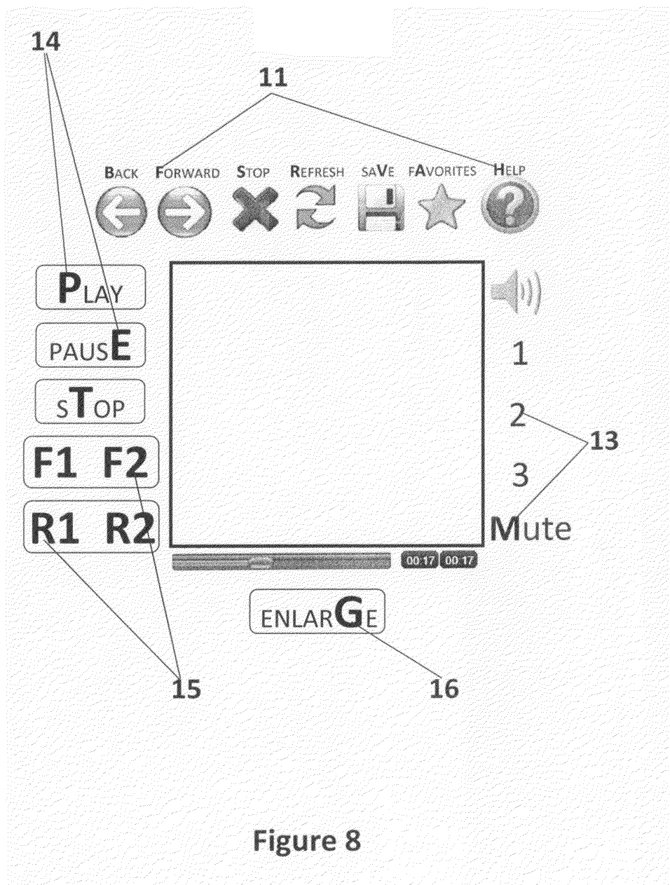

FIG. 8 shows what happens when a video is selected along with related options and navigation tools. It shares the window with the shadowed contents of the page it was on (although not shown in this figure),

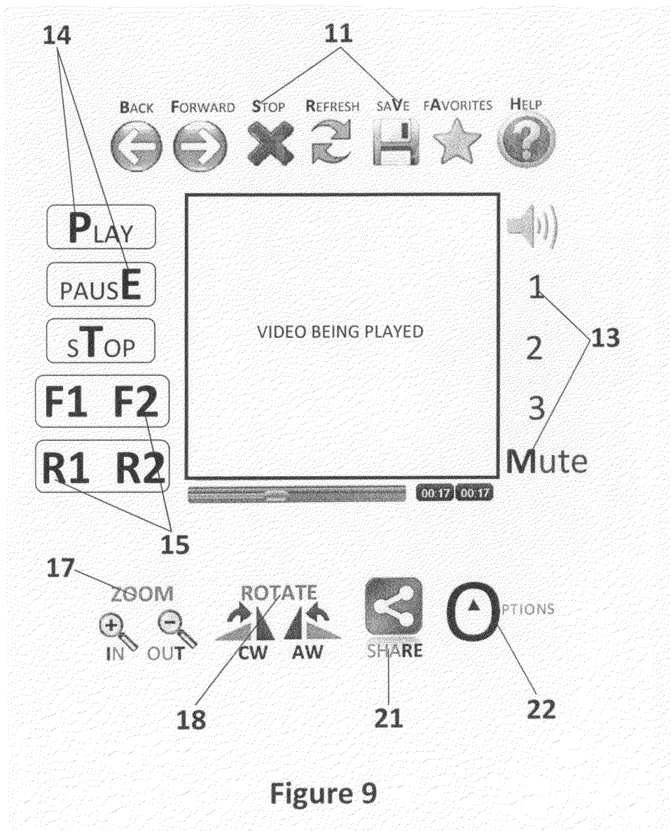

FIG. 9 shows a full window that will be visible once a certain video is selected; containing only an enlargened version of the desired video along with navigation options and further viewing options,

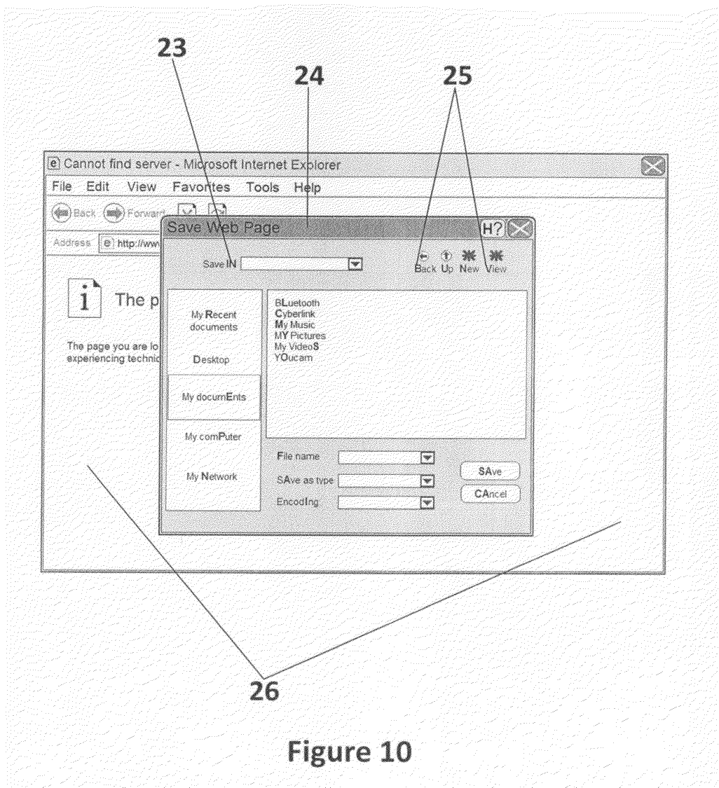

FIG. 10 shows a basic prompt screen that covers most aspects found in such screens, this ‘Save as’ screen is focused over a shadowed webpage from which this window was opened,

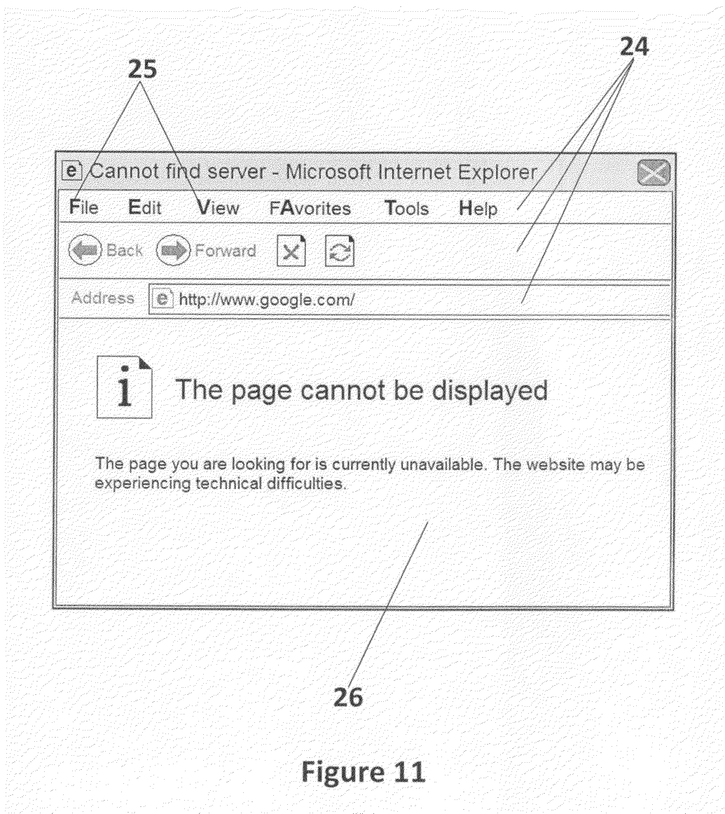

FIG. 11 shows the basic menu that will be found in most web browsers,

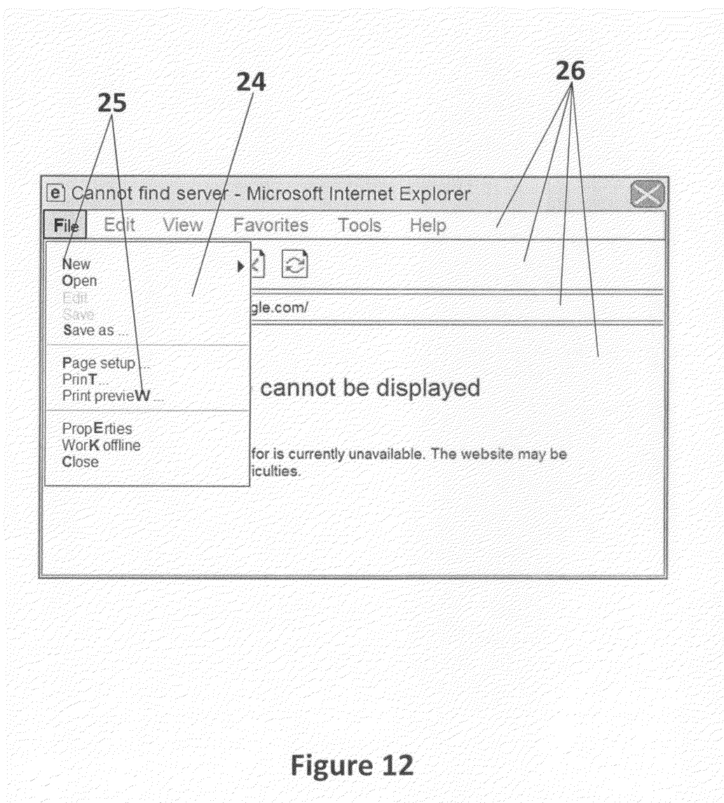

FIG. 12 shows the basic drop-down menu available when a certain option is selected from the main menu,

FIG. 1 shows random text containing hyperlinks just as you might see in a webpage. This page will only be displayed on the monitor of the user using a regular web browser and not using the plug-in. However, if the plug-in is used, then this screen will not be displayed to the user. The page will only be displayed once all hyperlinks have been tagged and formatted.

The hyperlinks (1) all lead to different pages once they are clicked on by a user without the plug-in. The regular text (2) will not open a new page once clicked by the same user as it is not a hyperlink.

FIG. 2 shows the first of the three loops in the algorithm. The page displayed is the result of loop 1 in which the plug-in scans the hyperlink, identifies a single unique letter and if present formats that letter. Formatting is done so as to make clear to the user what and where the voice-activated tag is. Note that this page will not be displayed to the user just yet as all hyperlinks have not been tagged.

The formatted hyperlinks (3) have been acted on. Regular text (2) has not been acted on as it is not a hyperlink. Striked and highlighted hyperlinks (4) contain no single unique letter hence they have not been tagged, instead they have been indexed for the second loop.

FIG. 3 shows the final view of the webpage that will be displayed to the user. This webpage displayed is the result of the second loop and in this case the final loop, the reason being that the third loop is not needed as the second loop dealt with all the indexed hyperlinks. Thus all hyperlinks were acted on causing the algorithm to cut short the last loop.

The reason for indexing hyperlinks in the first loop is to cut down the amount of text that has to be scanned in the next loop thus decreasing processing time; that is why this algorithm falls into the Divide and Conquer category.

The formatted hyperlinks (3) and the regular text (2) are unchanged as no further action is needed on them. Formatted hyperlinks (5) contain double unique lettered tags as no single unique letters existed in them to be tagged in the first loop.

FIG. 4 is independent of FIGS. 1, 2 and 3. It contains picture-only hyperlinks in which each box or hyperlink leads to a different page. This webpage would not be displayed to a user without the plug-in due to the presence of the grids that have been assigned to the webpage by the plug-in. This page will be displayed to a user using the plug-in, this page has produced a grid in such a way that any image can be selected.

The top grid (6) contains a letter-number combination that starts with ‘C1’ until ‘C9’ and then moves onto ‘D1’ and so on. The side grid (7) also contains the same combination but instead starts at ‘R1’ until ‘R9’ and then moves onto ‘S1’ and so on. These combinations are used to avoid any reusing of tags that might occur with the webpage text. Numbers are not used as the 3-loop algorithm also applies to number hyperlinks (although uncommon). Image hyperlinks (8) can be selected in two ways, either by selecting a column in which the desired image lies or by selecting a row in which the desired image lies. These will be discussed in the coming figures. There is a possibility that there may be too many columns so that the initial ‘C1’ may even reach ‘R1’ which is used for rows only. Also in the case of the row, the initial ‘R1’ may reach ‘Z9’ which is the limit, however, the chance and probability of this happening for either the row or column is just too little and insignificant.

Also, if however, the above situation does occur, the algorithm can assign any free letter-then-number-combination (A1 . . . Z9) which is free or not already used in the row, column or webpage. Moreover, since text hyperlinks in the page can also constitute letters or numbers or their combination in any order, there may be a case where the combinations used for these grids may already be assigned to a text hyperlink on a page by the algorithm. Thus there would be a repetition of tags, however, this is once again very rare and the probability of it happening is just too low. If it does happen, the algorithm will give priority to the webpage and assign a different tag for that column/row in that sideline grid; as in the solution to the previous case.

FIG. 5 is dependent on FIG. 4; FIG. 5 shows what would be displayed once a certain row is selected (R4). The horizontal row is selected based on the position of the desired picture, once the correct row is selected; it comes into focus by being magnified. At the same time, everything above and below that row becomes shadowed and deactivated. Basically, whatever is in focus can be selected; this means that tags can be reused.

To select an illustrative hyperlink, there is no direct step. Instead, you must either select a row first and then select the number above the desired image or select a column first and then select the number adjacent to the desired image. This cannot be done in one step; you have to say each step separately.

The menu that appears above the selected row is a navigation bar that will always appear when an image or a video is selected from a column or a row. The related text (11) above the icons has the algorithm applied so that a tag is created for every icons text. Furthermore, the Save and Favorites commands ‘V’ and ‘A’ respectively can be activated without the unnecessary opening of a new window or tab. For example, to save figure that has the number ‘10’ above it, you must say ‘V10’ together, it will then ask what name it should be saved as. Here, text can be entered using a voice recognition software that can be developed by standard software programming languages.

Once the image is opened by saying the desired number, the image will load on the page appearing magnified and accompanied by further options, this will be discussed later in FIG. 7.

Out-of-focus objects (9) will be visible but deactivated. Selected row (12) will be magnified for better viewing. Numbers (10) are used to select appropriate images.

FIG. 6 is independent of FIG. 5 but dependant on FIG. 4. Similar to FIG. 5, it is also what would be displayed once a certain column is selected. Once again the same navigation icons and text, along with the magnified column and numbers will appear. Every aspect of this screen is similar to the previous figure but instead of a row this is a column that is initially selected. Basically it is the user who is to decide which he would like to select first.

Out-of-focus objects (9) will be visible but deactivated. Selected row (12) will be magnified for better viewing. Numbers (10) are used to select appropriate images.

FIG. 7 shows a magnified version of the desired image along with navigation options and further viewing options, this is standard for all illustrative hyperlinks. This screen is the result of selecting a row or column and then selecting the appropriate adjacent number.

Zoom options (17), rotate options (18) and edit options (19) change the way in which the image is displayed. Print option (20) is used to print the enlargened version. Share option (21) once activated enables the user to send that current page link to a friend by means of e-mail. Options (22) opens a list of further options like; Save Background As . . . , Set as Background, Copy Background, Set as Desktop Item . . . , View Source, Encoding, Export to Excel and Properties.

FIG. 8 shows what would appear visible when a certain video is selected in the same manner as when an image is selected, but in this case the video does not open in a new page unless a further option is selected. On an actual webpage, all the surrounding text, graphics or hyperlinks would still be visible although not shown here. Here too, surrounding objects will be made out-of-focus and shadowed.

Once again navigation bar (11) provides easy surfing. Playback buttons (14) are tagged by the white letters. Forward and rewind options (15) are used in a slightly different manner. ‘F1’ forwards at a rate of 5 seconds every second as does ‘R1’ rewind at the same rate. ‘F2’ forwards at a rate of 10 seconds every second as does ‘R2’ rewind at the same rate. The utterance of either of these; ‘F1’, ‘F2’, ‘R1’, ‘R2’, will make a continuous forward or rewind until a command is said to stop the forward and rewind; these are ‘F’ and ‘R’ respectively.

Volume control icons (13) are used in the following manner: 1 changes volume to 33%, 2 changes to 66%, 3 changes to 100% or full volume and finally M (mute) changes volume to 0%.

Enlarge icon (16) opens the video in a larger format with more options on a whole page by itself, it is on par with selecting an image for detailed viewing (like in FIG. 7).

FIG. 9 like FIG. 8 shows a video viewing screen along with navigation options and further options but here it has been opened in a whole window unlike in FIG. 8 (the result of selecting the ‘Enlarge’ icon from FIG. 8). Selecting a row or a column and then selecting the appropriate adjacent number will not open the video in a new page but further enlarge it on the same page. Only if the ‘Enlarge’ option is selected will the video load onto the whole page.

Zoom options (17) and rotate options (18) provide means to a modified way of viewing. Share options (21) enable the user to send the link to a friend. Options (22) open further options like; Setting, About Adobe Flash Player, etc.

FIG. 10 can be selected from ‘File’ drop-down menu in the web browser. This screen has icons, drop-down menus and text boxes. When nameless icons are encountered, the algorithm superimposes the name of the icon underneath if not to its side as has been done to options (25). Since this is a window within the main window, there is also a close window option, i.e. by saying ‘X’. Help can be opened by saying H. This means that tags in the active window cannot be ‘X’ or ‘H’, i.e. ‘X’ or ‘H’ has been be removed from the table of available tags.

Active window (24) contains active tags. Inactive screen (26) is shadowed and contains inactive and reusable tags. Drop-down menu (23) can be opened as long as related text is adjacent so that a tag can be created (in this case it can be).

FIG. 11 shows a screen giving emphasis on how menus are opened, selected and closed. When surfing on a web page, the menu will be inactive until the word ‘MENU’ is said which deactivates the webpage, shadowing it and reusing its tags. As you can see, the basic menu for most web browsers includes a row of options at the top, an intermediate row containing icons and the bottom row containing an address bar.

The icons will have their names superimposed adjacent to them with formatting to create a unique tag. The address bar can be selected by saying ‘BAR’, however, if there is more than one bar, then say ‘BAR 1’, ‘BAR 2’ and so on (occurring from top to bottom and from left to right). To select the Go button say ‘GO’. Enter text using commercially available voice recognition software. To open the list of URL addresses say ‘DROP’ to open, and the same to close. Say ‘MENU’ to go back a single step in all cases within the menu. The menu itself can be closed in the same way.

Menu headings (25) have tags applied to them. Active area (24) contains active tags, although only the upper most row of drop down menus are shown here to have tags, the intermediate icons will have superimposed text with tags applied to them, the address bar will have its related text with corresponding tags. Inactive section (26) contains inactive hyperlinks that will be reused in the menu.

FIG. 12 shows a window in which the ‘File’ option has been opened by saying ‘F’. In this situation, the tag ‘F’ is not reused but the remaining letters can be. Once again, the word ‘MENU’ can be used to back-up a single step. Also note that only this drop-down menu comes into focus shadowing everything else around it.

Active tags (25) are present in the menu. Active section (24) contains these active tags. Inactive sections (26) contain no active tags and are shadowed.

1. A discrete character voice activated navigation system in the form of an executable plug-in for a wearable computer that enables users to navigate through web pages displayed in an internet web browser by speaking at least one discrete character assigned to a text hyperlink, the system having used an algorithm to check in each hyperlink for the presence of a single unique letter (SUL), double unique letter (DUL) and triple unique letters (TUL) in three successive loops of indexing and having assigned unique letter tags to the hyperlinks based on that indexing.

2. A discrete voice command navigation system as claimed in claim 1 wherein the system intercepts a webpage, scans it using a divide and conquer algorithm and locates and assigns discrete yet unique non-intrusive characters to text hyperlinks.

3. A discrete character voice activated navigation system as claimed in claim 1 wherein the system checks in each text hyperlink for the presence of a single unique letter, double unique letters and triple unique letters in three successive processing loops.

4. A discrete character voice navigation system as claimed in claim 1 wherein the processor tags or acts upon single unique letter containing text hyperlinks and indexes double and triple unique letter containing text hyperlinks in the first loop, tags or acts on double unique letter containing hyperlinks and indexes triple unique letter containing text hyperlinks in the second loop and tags or acts on the remaining indexed triple unique letter containing hyperlinks in order that all text hyperlinks are tagged by the end of the third loop.

5. A discrete character voice activated navigation system as claimed in claim 1 wherein the divide and conquer algorithm indexing method isolates non-unique characters in a text hyperlink in order to reduce the searchable quantity of characters and reduce processing time.

6. A discrete character voice activated navigation system as claimed in claim 1 wherein the text hyperlinks containing formatted letters map onto voice commands so that if the user speech matches the letters the hyperlink is activated and if they do not match, the voice commands are ignored.

7. A discrete character voice activated navigation system as claimed in claim 1 which initially performs the least formatting of the text only and ignores balloons, pop-ups, boxes, or other appended objects.

8. A discrete character voice activated navigation system as claimed in claim 1 which formats the text in the order of single unique letters being formatted in the first loop, double unique letters being formatted in the second loop and triple unique letters being formatted in the third loop.

9. A discrete character voice activated navigation system as claimed in claim 1 in which single unique letters are formatted in the first loop, double unique letters are formatted in the second loop and triple unique letters are formatted in the third loop.

10. A discrete character voice activated navigation system as claimed in claim 1 in which the formatting involves the converting of the set of unique letters to bold, italic, capital or red in order for the user to identify the tag which they are too speak or spell in order to launch the hyperlink.

11. A discrete character voice activated navigation system as claimed in claim 1 which is adaptable to illustrative or graphic hyperlinks through the use of two sideline grids tagged with distinct voice-activated character combinations, the grids being superimposed over a web page, one at the top or bottom and one at one of the sides which allow the user to specifically define a picture or a graphic within the body of a web-page.

12. A discrete character voice activated navigation system as claimed in claim 1 wherein the grid tags comprise the use of short combinations of a letter and a number so as to avoid any overlapping of tags used in the text hyperlinks.

13. A discrete character voice activated navigation system as claimed in claim 1 wherein the tags are created before the page is loaded in order to provide a complete voice activated interface for immediate use.

14. A discrete character voice activated navigation system as claimed in claim 1 wherein the user can select either a grid column or row and based on the selection, all illustrative hyperlinks in that corresponding column or row would come into focus by means of magnification while all other objects outside the magnification will become shadowed and dark, and then a number-only tag would be assigned to each magnified image in that corresponding column or row.

15. A discrete character voice activated navigation system as claimed in claim 1 wherein the use of discrete letters; which are said in a distinct and separate manner (exceptions being user-defined words and other pre-saved short words), cannot exceed 3 characters (exceptions being user-defined words and other pre-saved short words).

16. A discrete character voice activated navigation system as claimed in claim 1 which is adaptable to the navigation of scroll bars by the use of unique combinations of characters (in relation to the hyperlinks on the webpage) which would move the scroll bar a predefined limit towards either the right, left, top or bottom according to uttered command.

17. A discrete character voice activated navigation system as claimed in claim 1 which is adaptable to the navigation of menus by the utterance of a non-discrete voice command, i.e. ‘MENU’, which brings the web-browser menu into focus and deactivates the tags on the web page and reuses them on the menu bar by means of the divide and conquer algorithm.

18. A discrete character voice activated navigation system as claimed in claim 1 which is adaptable to the navigation of sub-menus (which are accessible by selecting a suitable menu from the menu bar) by the reuse of tags from the previous set of available menus which would become out of focus when a certain sub-menu (or any other menu lower down in the hierarchy) is selected.

19. A discrete character voice activated navigation system as claimed in claim 1 which scans the complete web page and can then either assign tags to all hyperlinks on that page in one cycle (the three loops of the divide and conquer algorithm) or assign tags to only those hyperlinks that are currently visible on the screen and then reuse those tags when the user scrolls down bringing the other hyperlinks in view (by means of repeating the three loops of the divide and conquer algorithm on every scroll).
